(19) United States
(12) Patent Application Publication
(10) Pub. No.: US 2026/0369261 A1
(43) Pub. Date: Nov. 19, 2026

(54) DIRECTIONALITY INDUCED VARIABLE STEP SIZE FOR ACOUSTIC ECHO CANCELLATION

(71) Applicant: GM Global Technology Operations LLC, Detroit, MI (US)

(72) Inventors: Amos Schreibman, Hod Hasharon (IL); Elior Hadad, Ness-Ziona (IL); Moshe Tzur, Petah Tikva (IL)

(73) Assignee: GM Global Technology Operations LLC, Detroit, MI (US)

(21) Appl. No.: 19/211,214

(22) Filed: May 18, 2025

(51) Int. Cl. G10K 11/178

(52) U.S. Cl. CPC G10K 11/17854; G10K 2210/1282; G10K 2210/3028; G10K 2210/505

(57) ABSTRACT

A computer-implemented method when executed by data processing hardware causes the data processing hardware to perform operations. The operations include receiving one or more audio signals at an adaptive filter, applying an adaptive filter weight to the one or more audio signals, obtaining, based on the applied adaptive filter weight, a residual echo, and determining, via an adaptive filter algorithm, a current directivity factor. The operations also include determining, via the adaptive filter algorithm, a directivity confidence measure, determining, via the adaptive filter algorithm, a forgetting factor of a recursive least square, applying an acoustic echo canceler (AEC) on the residual echo using the forgetting factor, updating, via the adaptive filter algorithm, an averaged filter, and updating a directivity mean and standard deviation of the adaptive filter.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to directionality induced variable step size for acoustic echo cancellation.

Acoustic echo cancellation (AEC) is a technique that aims to eliminate the echo that results from the acoustic coupling between a loudspeaker and a microphone in a full-duplex telecommunication system. AEC is essential for providing a natural and comfortable communication experience for the users, as well as for enhancing the performance of speech processing algorithms such as noise reduction, speech recognition, and speech enhancement. However, AEC is a challenging problem due to the complexity and variability of the acoustic environment, the presence of non-linearities, and the occurrence of double talk scenarios.

A common approach to AEC is to use an adaptive filter that models the acoustic impulse response between the loudspeaker and the microphone and subtracts the estimated echo signal from the microphone signal. However, this approach suffers from several limitations, such as slow convergence, filter divergence, residual echo, and speech distortion. These limitations are exacerbated by the presence of double talk, which refers to the situation when both the near-end and the far-end speakers talk simultaneously. Double talk poses a trade-off between echo cancellation and speech preservation, as the adaptive filter needs to balance between adapting to the changing echo path and avoiding interference with the near-end speech. Therefore, there is a need for an improved adaptive filter that can effectively handle double talk situations and improve the speech quality and the noise suppression.

### SUMMARY

In some aspects, a computer-implemented method when executed by data processing hardware causes the data processing hardware to perform operations. The operations include receiving one or more audio signals at an adaptive filter, applying an adaptive filter weight to the one or more audio signals, obtaining, based on the applied adaptive filter weight, a residual echo, and determining, via an adaptive filter algorithm, a current directivity factor. The operations also include determining, via the adaptive filter algorithm, a directivity confidence measure, determining, via the adaptive filter algorithm, a forgetting factor of a recursive least square, applying an acoustic echo canceler (AEC) on the residual echo using the forgetting factor, updating, via the adaptive filter algorithm, an averaged filter, and updating a directivity mean and standard deviation of the adaptive filter.

In some examples, a near end source may be preserved after applying the AEC during a double talk segment. Optionally, determining the current directivity factor may include utilizing a direction of at least one near end source and estimating, via the adaptive filter algorithm, a maximal current directional energy. In some instances, estimating the maximal current directional energy may include obtaining an acoustic transfer function vector. The operations may also include determining a directional energy measure including identifying a quotient of the maximal current directional energy and a residual directional energy. The operations may further include determining the residual directional energy based on a difference between an output residual echo and the maximal current directional energy. In other examples, applying the AEC may include executing one or more iterations of the AEC and averaging the adaptive filter weight of each of the one or more iterations. Optionally, updating the directivity mean and the standard deviation may include evaluating a residual echo directivity during exclusive far end phases.

An adaptive filter system configured to execute the operations. A vehicle may be equipped with the adaptive filter system.

In other aspects, an adaptive filter system includes data processing hardware and memory hardware in communication with the data processing hardware. The memory hardware stores instructions that when executed on the data processing hardware cause the data processing hardware to perform operations. The operations include receiving one or more audio signals at an adaptive filter, applying an adaptive filter weight to the one or more audio signals, obtaining, based on the applied adaptive filter weight, a residual echo, and determining, via an adaptive filter algorithm, a current directivity factor. The operations also include determining, via the adaptive filter algorithm, a directivity confidence measure, determining, via the adaptive filter algorithm, a forgetting factor of a recursive least square, and applying an acoustic echo canceler (AEC) on the residual echo using the forgetting factor. The operations further include updating, via the adaptive filter algorithm, an averaged filter and updating a directivity mean and standard deviation of the adaptive filter.

In some examples, a near end signal may be preserved after applying the AEC during a double talk segment. Optionally, determining the current directivity factor may include utilizing a direction of at least one near end source and estimating, via the adaptive filter algorithm, a maximal current directional energy. In some instances, estimating the maximal current directional energy may include obtaining an acoustic transfer function vector. The operations may include determining a directional energy measure including identifying a quotient of the maximal current directional energy and a residual directional energy. The operations may include determining the residual directional energy based on a difference between an output residual echo and the maximal current directional energy. In other examples, applying the AEC may include executing one or more iterations of the AEC and averaging the adaptive filter weight of each of the one or more iterations. Optionally, updating the directivity mean and the standard deviation includes evaluating a residual echo directivity during exclusive far end phases.

A vehicle may be equipped with the adaptive filter system.

In further aspects, an adaptive filter system includes data processing hardware and memory hardware in communication with the data processing hardware. The memory hardware stores instructions that when executed on the data processing hardware cause the data processing hardware to perform operations. The operations include receiving one or more audio signals at an adaptive filter, applying an adaptive filter weight to the one or more audio signals, obtaining, based on the applied adaptive filter weight, a residual echo, and determining, via an adaptive filter algorithm, a current directivity factor. The operations also include estimating, via the adaptive filter algorithm, a maximal current directional energy, obtaining an acoustic transfer function vector, determining a directional energy measure including identifying a quotient of the maximal current directional energy and a residual directional energy, and determining the residual directional energy based on a difference between an output residual echo and the maximal current directional energy. The operations further include determining, via the adaptive filter algorithm, a directivity confidence measure, determining, via the adaptive filter algorithm, a forgetting factor of a recursive least square, applying an acoustic echo canceler (AEC) on the residual echo using the forgetting factor, updating, via the adaptive filter algorithm, an averaged filter, and updating a directivity mean and standard deviation of the adaptive filter.

### BRIEF DESCRIPTION OF THE DRAWINGS

The drawings described herein are for illustrative purposes only of selected configurations and are not intended to limit the scope of the present disclosure.

FIG. 1 is a schematic diagram of a vehicle equipped with an adaptive filter;

FIG. 2 is an example block diagram for an adaptive filter system according to the present disclosure;

FIG. 3 is another example block diagram for the adaptive filter system of FIG. 2;

FIG. 4 is a schematic diagram of an adaptive filter system according to the present disclosure; and

FIG. 5 is an example flow diagram of a method of operation of an adaptive filter system according to the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

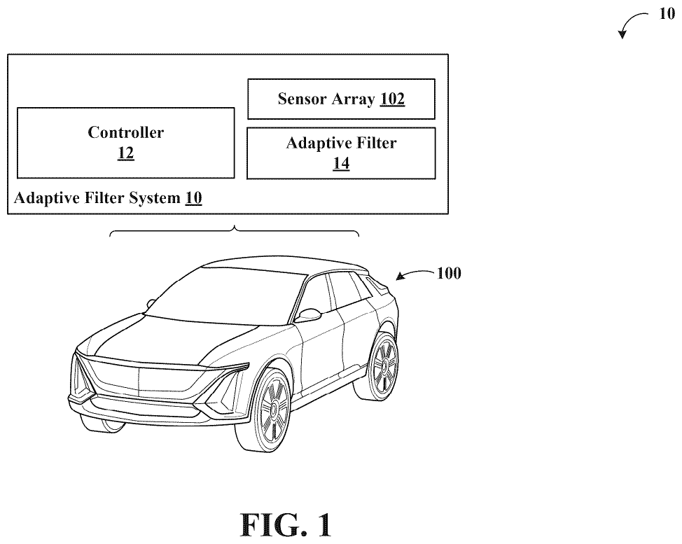

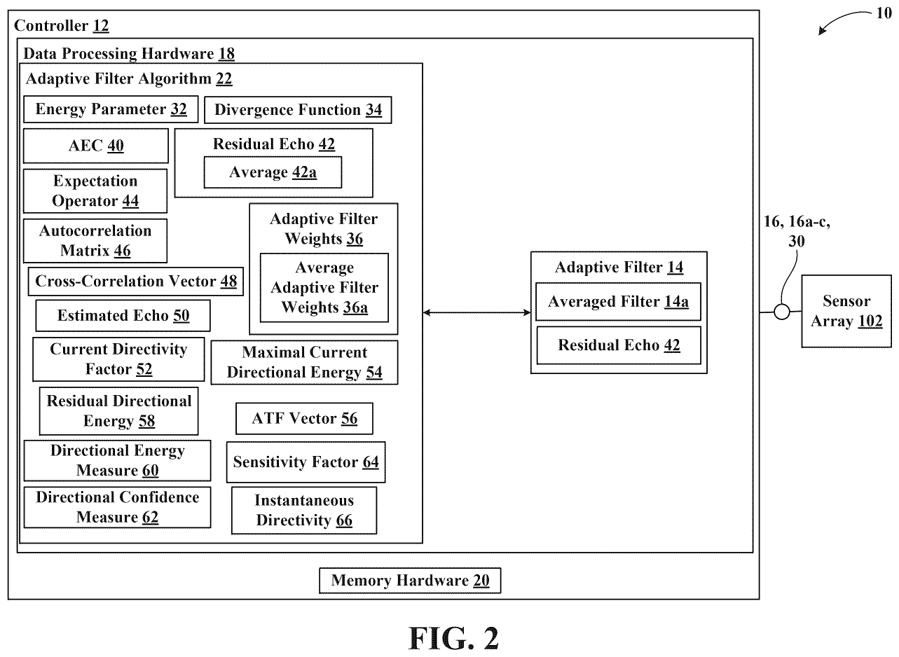

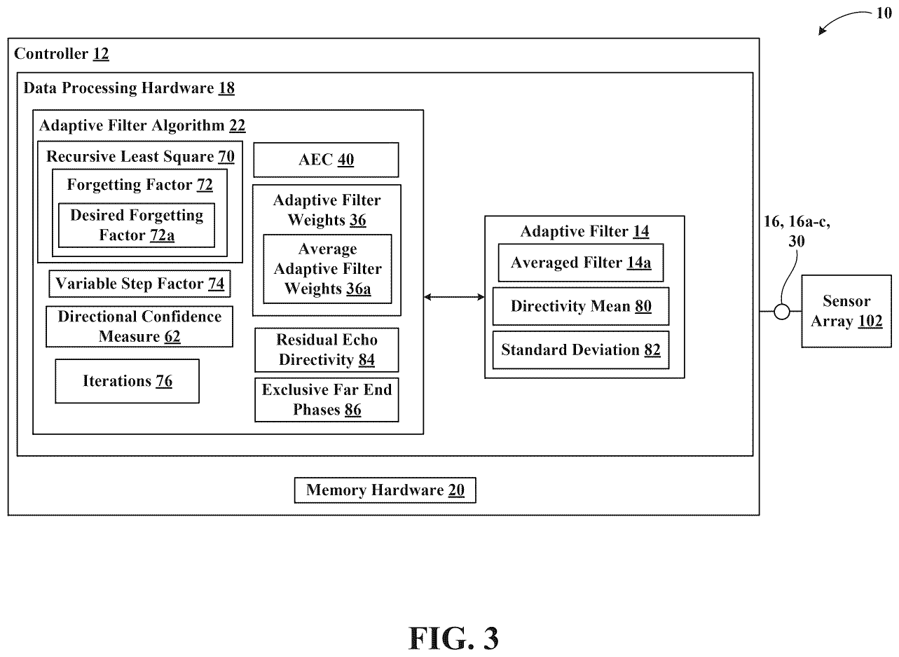

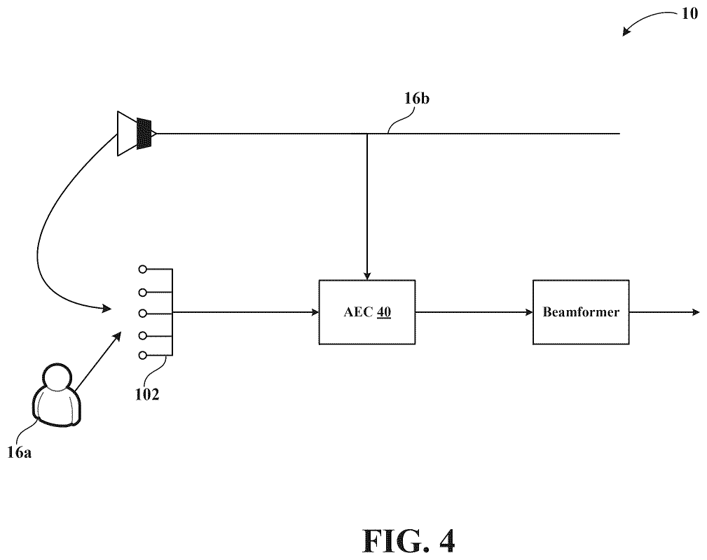

Referring to FIGS. 1-4, an adaptive filter system 10 according to the present disclosure for a vehicle 100 includes a controller 12 configured with an adaptive filter 14. It is also contemplated that in other examples, the adaptive filter system 10 may be utilized in computer systems other than with respect to a vehicle. Such examples include, but are not limited to, mobile devices, headsets, earphones, speaker systems, and any other practicable device utilizing voice-to-voice and/or voice-to-machine (ASR) communication via an audio system. The adaptive filter system 10 is described herein with respect to the vehicle 100 for exemplary purposes.

The adaptive filter system 10 may be electrically coupled to a sensor array 102 of the vehicle 100 to receive audio signals or sources 16. In some examples, the sensor array 102 may include a microphone array and/or a loudspeaker within the vehicle 100 configured to capture, at least in part, the audio signals 16. The audio signals 16 include a near end source 16a and a far end source 16b. The audio signals 16 are received by the adaptive filter 14 and are processed through the adaptive filter system 10, described herein.

The adaptive filter system 10 coordinates the controller 12 with the adaptive filter 14 to monitor the audio signals 16 and adjust an audio output from the adaptive filter system 10. The controller 12 includes data processing hardware 18 and memory hardware 20 that may store instructions and operations of the adaptive filter system 10 that may be executed by the data processing hardware 18. In some examples, the adaptive filter 14 may be configured as part of the controller 12. For example, the data processing hardware 18 of the controller 12 may be configured to execute an adaptive filter algorithm 22 in connection with running the adaptive filter 14. In other examples, the adaptive filter 14 may be separate from the controller 12 and may be in communication with the controller 12.

With further reference to FIGS. 1-4, the adaptive filter system 10 is configured to calculate energy 30 from a location (i.e., the near end source 16a) to determine an energy parameter 32. The energy 30 is measured from the near end source 16a when the far end source 16b is active. The energy parameter 32 is utilized to determine whether the near end source 16a is active. For example, the adaptive filter system 10 looks at a change in the energy 30 and a direction of the energy 30 to determine whether the near end source 16a is active. The adaptive filter system 10 executes a divergence function 34 to average adaptive filter weights 36a of the adaptive filter 14, described below.

For example, the adaptive filter algorithm 22 may be configured with an acoustic echo canceler (AEC) 40 in the Short-Time Fourier Transform (STFT) domain. For example, the AEC 40 may be formulated as:

Z=D−W^{H}X (a)

Where Z is a residual echo 42, D is an input signal 16 (i.e., the near end source 16a), X is a reference signal 16 (i.e., the far end signal 16b), and W is the adaptive filter weight 36, described below. The AEC 40 is configured to adapt the adaptive filter weight 36 when there is no active near end source 16a. For example, the adaptive filter weight 36 adaptation may be formulated as:

Wₒₚₜ=argmin_{w}E{|Z|²}=R⁻¹p (b)

Where E is an expectation operator 44, Z is the residual echo 42, R is the estimated reference autocorrelation matrix (i.e., autocorrelation matrix 46), p is the estimated reference-to-input cross-correlation vector (i.e., cross-correlation vector 48), and argmin_{w} is an optimal solution that minimizes the product of the expectation operator and the function of the residual echo 42. As described below, the residual echo 42 may be free of double talk.

The adaptive filter algorithm 22 of the controller 12 is configured to execute the divergence function 34 that utilizes, as mentioned above, an average 36a of the adaptive filter weights 36. The divergence function 34 is configured to minimize and/or prevent convergence between a desired source 16c and an estimated echo 50. Rather, the divergence function 34 adjusts the adaptive filter algorithm 22 to utilize the average 36a of the adaptive filter weights 36. The adaptive filter weights 36 are applied to the audio signals 16 and may result in obtaining the residual echo 42. The residual echo 42 may be an outcome of the adaptive filter 14. At the beginning of each iteration, the residual echo 42 is attenuated by applying the average 36a of the adaptive filter weights 36 to provide an average 42a of the residual echo 42.

With further reference to FIGS. 1-4, the adaptive filter algorithm 22 may then determine a current directivity factor 52. The current directivity factor 52 may generally correspond to a maximal current directional energy 54. For example, the adaptive filter algorithm 22 may obtain an acoustic transfer function (ATF) vector 56 of each of the desired sources 16c (i.e., near end sources 16a). The ATF vector 56 may be obtained using different methods including, but not limited to, a beamformer and/or being calculated during a pre-tuning stage. The ATF vector 56 is utilized with the direction of each of the desired sources 16c (i.e., near end sources 16a) to determine the maximal current directional energy 54. For example, the maximal current directional energy 54 may be calculated using the formula:

$${Eng}_{Des} ( n ) = {max}_{i} \{ {\vert {S}_{i}^{H} {Z}_{avg} ( n ) \vert}^{2} \} \qquad ( c )$$

Where Sᵢ is the direction of the ATF vector 56 and the direction of the desired source 16c, H is a Hermitian operator, and Z_{avg} is the average 42a of the residual echo 42. Further, a residual directional energy 58 is calculated based on the difference between the average residual echo 42a and the maximal current directional energy 54. For example, the residual directional energy 58 may be calculated using the formula:

$${Eng}_{res} ( n ) = {Z}_{avg}^{H} ( n ) {Z}_{avg} ( n ) - {Eng}_{Des} ( n ) \qquad ( d )$$

The residual directional energy 58 corresponds to how much energy is given in the adaptive filter system 10 besides the energy emitted from the desired source 16. The residual directional energy 58 takes the total energy and subtracts the energy that is emitted from the desired source 16c. If there is no directional energy emitted from the desired source 16c and/or there is no speaker located in the near end, then the residual directional energy 58 tends to a constant value. Once the desired source 16c starts speaking and there is an audio signal 16, then a directional energy measure 60, determined using the maximal current directional energy 54 will increase and the residual directional energy 58, will decrease. For example, the directional energy measure 60 may be calculated using the formula:

Dir(n)=Eng_{Des}(n)/Engᵣₑₛ(n) (e)

In other words, the directional energy measure 60 may be determined by identifying a quotient of the maximal current directional energy 54 and the residual directional energy 58. For example, the maximal current directional energy 54 is divided by the residual directional energy 58 to obtain the directional energy measure 60. The directional energy measure 60 trends to an infinite number (i.e., infinity) for a directional signal in the direction of the desired source 16c. In other instances, the directional energy measure 60 may trend to a constant value for ambient noise or the residual echo 42, which is a result of the use of the average 36a of the adaptive filter weights 36. A mean of the directional energy measure 60 is measured throughout a conversation (i.e., when the audio signals 16 are present) to obtain a base value.

Referring still to FIGS. 1-4, the adaptive filter algorithm 22 is configured to determine a directivity confidence measure 62. The directivity confidence measure 62 reflects a confidence that the audio signals 16 are exclusively from the far end source 16b. The directivity confidence measure 62 utilizes a sensitivity factor 64 to tune the directivity confidence measure 62 and control the overall sensitivity of the directivity confidence measure 62. For example, if the sensitivity factor 64 has a high value, then the less sensitive the adaptive filter 14 will be. The sensitivity factor 64 may be determined by obtaining the standard deviation of the directional energy measure 60.

The directivity confidence measure 62 may tend toward one (1) and/or tend toward zero (0). For example, if the directivity confidence measure 62 tends toward one (1), then the assessment is that there are exclusive far end phases. In comparison, if the directivity confidence measure 62 tends toward zero (0), then there is an active near end phase. The directivity confidence measure 62 may be calculated using the formula:

u(n)=Db2Mag{Dirₘₑₐₙ(n)+ADir_{std}(n)}/Dir(n) (f)

Where A is the sensitivity factor 64 and Db2Mag{x} is equal to 10^{x/20}. The directivity confidence measure 62 may be described as being a comparison of the mean of the emitted energy 30 from the desired source 16c divided by an instantaneous directivity 66. The instantaneous directivity 66 will tend toward one (1) when audio signals 16 from the only the far end source 16b are detected. For example, the instantaneous directivity 66 will primarily exist when close to the mean. Once the desired source 16c starts speaking, then the instantaneous directivity 66 will trend to infinity and the mean will stay the same. As a result, the confidence measure 62 will tend toward zero (0). In either instance, the instantaneous directivity 66 may be utilized to determine the confidence measure 62. There is an inverse relationship between the instantaneous directivity 66 and the confidence measure 62 in that as the instantaneous directivity 66 increases to higher values, the confidence measure 62 tends towards zero (0).

Referring still to FIGS. 1-4, the adaptive filter algorithm 22 also utilizes a recursive least square 70 that includes a forgetting factor 72. The forgetting factor 72 corresponds to the product of a variable step factor 74 and a desired forgetting factor 72a. For example, the forgetting factor 72 may be determined using the formula:

λ(n)=α²(n)\tilde{λ} (g)

Where α is the variable step factor 74 and \tilde{λ} is the desired forgetting factor 72a. The variable step factor 74 may be defined based on the presence of double talk. For example, when double talk is absent, the variable step factor 74 is equal to one (1), and the desired forgetting factor 72a may be fully adapted (i.e., used as the forgetting factor 72). If double talk is present, the desired forgetting factor 72a is stagnant, such that adaptation is stagnant. The presence of double talk corresponds to a low confidence measure 62, whereas adaptation of the desired forgetting factor 72a corresponds to a high confidence measure 62.

The adaptive filter algorithm 22 utilizes the forgetting factor 72 in combination with applying the AEC 40. For example, the AEC 40 may be applied on the residual echo 42 using the forgetting factor 72. The near end source 16a is preserved after applying the AEC 40 during a double talk segment, and the adaptive filter algorithm 22 may execute one or more iterations 76 of the AEC 40. The adaptive filter algorithm 22 averages the adaptive filter weight 36 at the end of a respective iteration of the AEC 40. The averaging of the adaptive filter 14 results in an averaged filter 14a that reduces double talk divergence effects and reduces echo attenuation. The adaptive filter algorithm 22 updates the average filter 14a, and the average filter 14a attenuates the residual echo 42 to achieve an average residual echo 42a that is utilized in adjusting the operation of the AEC 40.

With further reference to FIGS. 1-4, the adaptive filter algorithm 22 also updates a directivity mean 80 and a standard deviation 82 of the adaptive filter 14 based on the attenuated AEC 40. For example, at the end of each iteration 76, an average of the directional energy measure 60 (i.e., the directivity mean 80) and the standard deviation 82 are calculated for each active far end source 16b in the log domain. The directivity mean 80 may be calculated using the formula:

Dirₘₑₐₙ(n)=λₘₑₐₙDirₘₑₐₙ(n−1)+(1−λₘₑₐₙ)20 log₁₀{Dir(n)}) (h)

The standard deviation 82 may be calculated using the formula:

Dir_{std}(n)=λ_{std}Dir_{std}(n−1)+(1−λ_{std})|Dirₘₑₐₙ(n−1)−20 log₁₀{Dir(n)}| (i)

The calculation of the average of the directivity mean 80 and the standard deviation 82 using the log domain relaxes the dynamic range induced by the initial calculation of the directional energy measure 60. As a result, the adaptive filter system 10 evaluates a residual echo directivity 84 during exclusive far end phases 86.

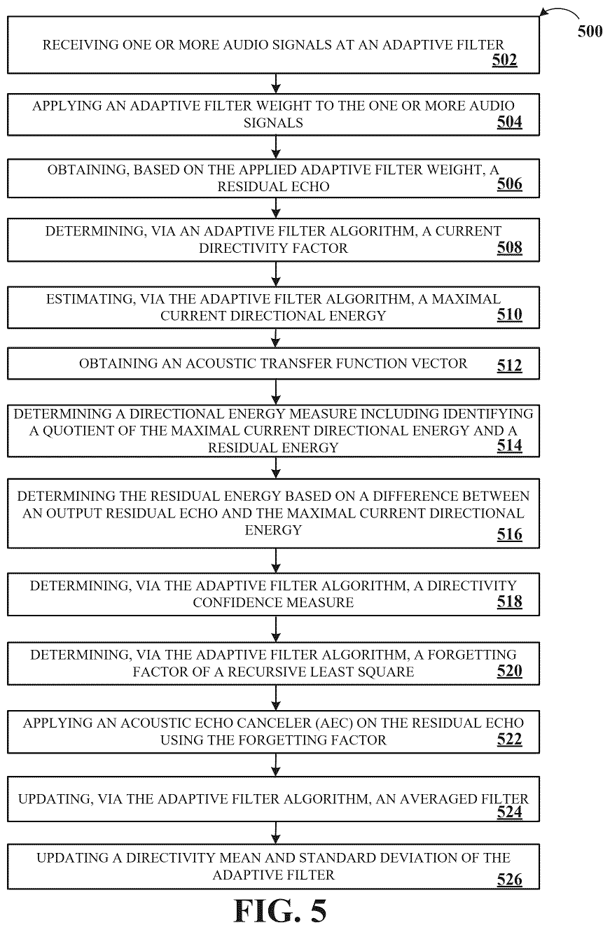

With specific reference to FIG. 5, an exemplary method 500 of operation of the adaptive filter system 10 is illustrated. At 502, one or more audio signals 16, 16a-c are received at an adaptive filter 14. At 504, an adaptive filter weight 36 is applied to the one or more audio signals 16, and at 506, a residual echo is obtained based on the applied adaptive filter weight. At 508, an adaptive filter algorithm 22 determines a current directivity factor 52 and estimates, at 510, a maximal current directional energy 54. At 512, an acoustic transfer function vector 56. At 514, a directional energy measure 60 is determined including identifying a quotient of the maximal current directional energy 54 and a residual directional energy 58. The residual directional energy 58 is determined, at 516, based on a difference between an output residual echo 42 and the maximal current directional energy 54. At 518, the adaptive filter algorithm 22 determines a directivity confidence measure 62. At 520, the adaptive filter algorithm 22 determines a forgetting factor 72 of a recursive least square 70 and, at 522, applies an acoustic echo canceler (AEC) 40 on the residual echo 42 using the forgetting factor 72. At 524, the adaptive filter algorithm 22 updates an averaged filter 14a and, at 526, updates a directivity mean 80 and standard deviation 82 of the adaptive filter 14.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed by data processing hardware causes the data processing hardware to perform operations comprising:
receiving one or more audio signals at an adaptive filter;
applying an adaptive filter weight to the one or more audio signals;
obtaining, based on the applied adaptive filter weight, a residual echo;
determining, via an adaptive filter algorithm, a current directivity factor;
determining, via the adaptive filter algorithm, a directivity confidence measure;
determining, via the adaptive filter algorithm, a forgetting factor of a recursive least square;
applying an acoustic echo canceler (AEC) on the residual echo using the forgetting factor;
updating, via the adaptive filter algorithm, an averaged filter; and
updating a directivity mean and standard deviation of the adaptive filter.

2. The method of claim 1, wherein a near end source is preserved after applying the AEC during a double talk segment.

3. The method of claim 1, wherein determining the current directivity factor includes utilizing a direction of at least one near end source and estimating, via the adaptive filter algorithm, a maximal current directional energy.

4. The method of claim 3, wherein estimating the maximal current directional energy includes obtaining an acoustic transfer function vector.

5. The method of claim 4, further including determining a directional energy measure including identifying a quotient of the maximal current directional energy and a residual directional energy.

6. The method of claim 5, further including determining the residual directional energy based on a difference between an output residual echo and the maximal current directional energy.

7. The method of claim 1, wherein applying the AEC includes executing one or more iterations of the AEC and averaging the adaptive filter weight of each of the one or more iterations.

8. The method of claim 1, wherein updating the directivity mean and the standard deviation includes evaluating a residual echo directivity during exclusive far end phases.

9. An adaptive filter system configured to execute the method of claim 1.

10. A vehicle equipped with the adaptive filter system of claim 9.

11. An adaptive filter system comprising:
data processing hardware; and
memory hardware in communication with the data processing hardware, the memory hardware storing instructions that when executed on the data processing hardware cause the data processing hardware to perform operations comprising:
receiving one or more audio signals at an adaptive filter;
applying an adaptive filter weight to the one or more audio signals;
obtaining, based on the applied adaptive filter weight, a residual echo;
determining, via an adaptive filter algorithm, a current directivity factor;
determining, via the adaptive filter algorithm, a directivity confidence measure;
determining, via the adaptive filter algorithm, a forgetting factor of a recursive least square;
applying an acoustic echo canceler (AEC) on the residual echo using the forgetting factor;
updating, via the adaptive filter algorithm, an averaged filter; and
updating a directivity mean and standard deviation of the adaptive filter.

12. The adaptive filter system of claim 11, wherein a near end signal is preserved after applying the AEC during a double talk segment.

13. The adaptive filter system of claim 11, wherein determining the current directivity factor includes utilizing a direction of at least one near end source and estimating, via the adaptive filter algorithm, a maximal current directional energy.

14. The adaptive filter system of claim 13, wherein estimating the maximal current directional energy includes obtaining an acoustic transfer function vector.

15. The adaptive filter system of claim 14, further including determining a directional energy measure including identifying a quotient of the maximal current directional energy and a residual directional energy.

16. The adaptive filter system of claim 15, further including determining the residual directional energy based on a difference between an output residual echo and the maximal current directional energy.

17. The adaptive filter system of claim 11, wherein applying the AEC includes executing one or more iterations of the AEC and averaging the adaptive filter weight of each of the one or more iterations.

18. The adaptive filter system of claim 11, wherein updating the directivity mean and the standard deviation includes evaluating a residual echo directivity during exclusive far end phases.

19. A vehicle equipped with the adaptive filter system of claim 11.

20. An adaptive filter system comprising:
data processing hardware; and
memory hardware in communication with the data processing hardware, the memory hardware storing instructions that when executed on the data processing hardware cause the data processing hardware to perform operations comprising:
receiving one or more audio signals at an adaptive filter;
applying an adaptive filter weight to the one or more audio signals;
obtaining, based on the applied adaptive filter weight, a residual echo;
determining, via an adaptive filter algorithm, a current directivity factor;
estimating, via the adaptive filter algorithm, a maximal current directional energy;
obtaining an acoustic transfer function vector;
determining a directional energy measure including identifying a quotient of the maximal current directional energy and a residual directional energy;
determining the residual directional energy based on a difference between an output residual echo and the maximal current directional energy;
determining, via the adaptive filter algorithm, a directivity confidence measure;
determining, via the adaptive filter algorithm, a forgetting factor of a recursive least square;
applying an acoustic echo canceler (AEC) on the residual echo using the forgetting factor;
updating, via the adaptive filter algorithm, an averaged filter; and
updating a directivity mean and standard deviation of the adaptive filter.
